(19) United States
(12) Patent Application Publication
(10) Pub. No.: US 2012/0193819 A1
(43) Pub. Date: Aug. 2, 2012

(54) COUPLING ELEMENT FOR CONNECTING AN AERATION BODY WITH THE FEED LINE OF A WATER AERATING DEVICE

(75) Inventor: Peter Kröner, Munchen (DE)

(73) Assignee: BIOWORKS VERFAHRENSTECHNIK GMBH, Putzbrunn (DE)

(21) Appl. No.: 13/389,722

(22) PCT Filed: Jul. 16, 2010
(86) PCT No.: PCT/EP2010/004363

§ 371 Date: Apr. 6, 2012

(30) Foreign Application Priority Data
Aug. 17, 2009 (DE) 10 2009 037 760.3

(51) Int. Cl. B01F 3/04; F16L 41/12

(52) U.S. Cl. 261/121.1; 285/197; 261/120

(57) ABSTRACT

The invention relates to a coupling element for connecting at least one aeration body to the feed line of a water aerating device. According to the invention, said coupling element has at least one integrated flow channel for a gaseous medium along a curved section, the inlet opening and outlet opening of said channel being arranged at different angular positions. The invention further relates to an aerating device for introducing a gaseous medium into a body of water, comprising at least one such coupling element

The invention relates to a coupling element for connecting at least one aeration body to the feed line of a water aerating device. The invention further relates to an aerating device for introducing a gaseous medium into a body of water.

Water aerating devices are known from prior art, reference being made, for instance, to patents DE 32 27 672 C2 and EP 0 437 718 B1. One such aeration device comprises multiple aeration bodies arranged in the water and from which a gas, particularly air, emerges for aerating the body of water. The aeration bodies receive a supply via one or more feed lines to the surface of the water body to which the aeration bodies are connected by feed lines. For this purpose outlets in the form of holes or tappings bottom the feed lines connected by couplings or sleeves, particularly by welding. Known furthermore from prior art are diverse coupling elements as shown in patents DE 32 27 672 C2 and EP 0 437 718 B1. The disadvantages of this prior art are the complications in installing, servicing and repairing the systems.

It is thus the object of the invention to propose a coupling element which avoids or at least greatly diminishes the disadvantages known from prior art, particularly in defining how it is now possible to avoid the disadvantages associated with prior art.

This object is achieved by a coupling element as set forth in claim 1 and by an aeration device as set forth in the further independent claim, whilst preferred and advantageous embodiments read from the sub-claims.

The coupling element in accordance with the invention serves to connect at least one aeration body to the feed line of a water aerating device, whereby this coupling element has at least one integrated flow channel for a gaseous medium along an elbow section, the inlet opening and outlet opening of said channel being arranged at different angular positions.

In the fitted condition the inlet opening of the flow channel integrated in the coupling element corresponds with at least one outlet opening in the feed line and the outlet opening corresponds with at least one discharge opening to the aeration body. Because of the inlet opening and outlet opening being arranged at different angular positions the outlet opening in the feed line and the discharge opening to the aeration body can now be arranged spaced from each other in thus now making it possible e.g. to position the outlet opening in a portion offering facilitated access in the feed line, i.e. practically independently of how the discharge opening to the aeration body is positioned.

Making use of such a coupling element now offers the advantage of it no longer being needed to weld the couplings or sleeves to the feed line which involved many complications particularly in situ. When disassembling, there is no longer any need to interfere with the water body to gain access to the inlet conduit and aeration body since a coupling element can now be preassembled with a inlet conduit and an aeration body, requiring it simply to be fitted to the feed line in situ.

In one preferred aspect the inlet opening is arranged at the top and the outlet opening at the bottom in a preferred fitted position of the coupling element, it being especially provided for that the inlet opening in relation to the cross-section of the feed line is positioned at roughly 12 o'clock and the outlet opening facing at roughly 6 o'clock displaced by 180°. This now makes it possible that the outlet opening in the feed line is located above the surface of the water body, whilst the discharge opening, the same as before, is located below the surface of the water body, resulting in a number of advantages which are especially effective in fitting during operation of a water aerating device.

This enables the opening to be made at the top into the feed line in this being located above the surface of the water body in thus greatly simplifying and saving time in fitting. When the coupling element is dismantled for servicing the top openings can now be plugged, even for a lengthy period of time without disrupting continued operation of the water aerating device. During fitting, servicing and/or repair the top openings located above the surface in the water body can also remain open temporarily. In other words, closing off these openings immediately the same as a bottom opening is no longer a mandatory requirement to prevent the ingress of water at 10 o'clock

In another preferred aspect the inlet opening is arranged roughly as regards a preferred location of the coupling element and the outlet opening at the bottom.

In yet another preferred aspect of the coupling element two elbows are releasably connected to an elbow section by preferably two couplings which facilitate replacing parts whilst helping in preventing loss of the elbows during fitting.

The invention also extends to an aeration device for introducing a gaseous medium into a water body, particularly for introducing a gaseous medium into a water treatment basin comprising at least one feed line and at least one adjoining coupling element serving to connect at least one aeration body to said feed line which is particularly engineered as a floating feed line.

For a better understanding of the invention it will now be detailed by way of example embodiments with reference to the drawing, in which:

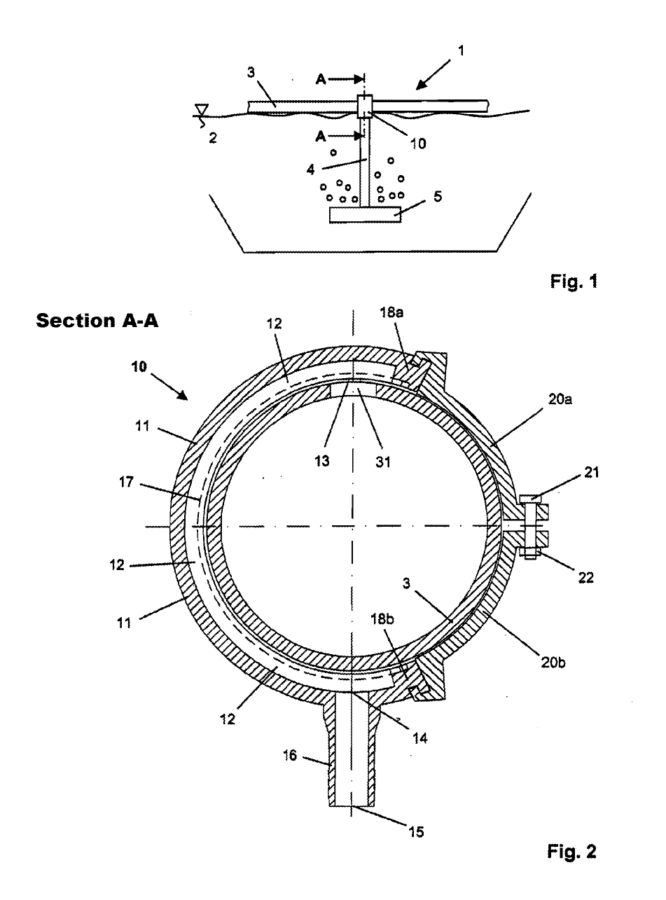

FIG. 1 is a diagrammatic representation of an aeration device in accordance with the invention for aerating water bodies.

FIG. 2 is a section through a coupling element in accordance with the invention as shown in FIG. 1.

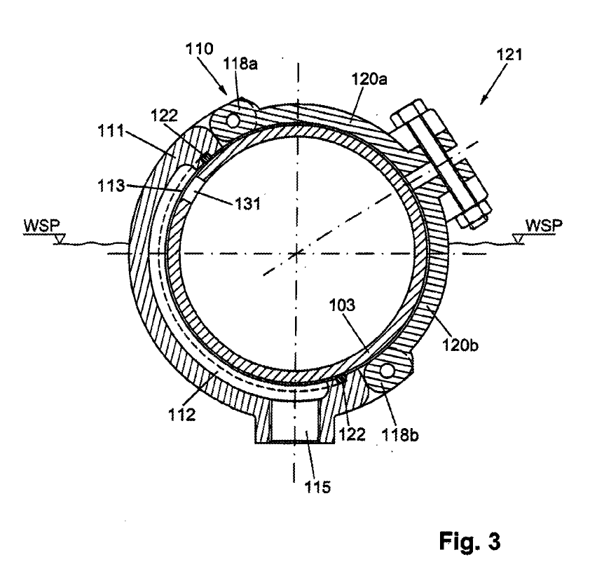

FIG. 3 is a section through a further variant of the coupling element in accordance with the invention as shown in FIG. 1.

Referring now to FIG. 1 there is illustrated an aeration device 1 comprising a feed line 3 configured floating on the surface of a water body 2 which may be, for example, a water treatment basin such as e.g. a sewage basin or sludge basin of a biological sewage plant. Located in the water body 2 and thus below the surface of the water body is an aeration body 5 for issuing a gaseous medium, particularly air, it being coupled via an inlet conduit 4 to the feed line 3 in supplying the gaseous medium. The inlet conduit 4 serves furthermore for fastening the aeration body 5 to the feed line 3 which may be configured as a flexible hose or as a rigid pipe. The connection between the inlet conduit 4 and the feed line 3 is made by means of a coupling element 10. Instead of an inlet conduit 4 an aeration body 5 may also be directly connected to the coupling element 10.

Referring now to FIG. 2 there is illustrated in a section view the coupling element 10 in a preferred embodiment in accordance with the section A-A in FIG. 1. This depicts a preferred fitted position of the coupling element 10.

The coupling element 10 is configured in the form of a pipe clamp comprising an elbow or circumferential section engineered as a C elbow 11 for mounting top-down on the feed line 3 by its open end, the C elbow 11 making a positive connection to the circular ring-shaped pipe of the feed line 3. To permit mounting, the coupling element 10 is configured preferably in one piece of a flexible and waterproof plastics material, for instance as an injected molded part, which may be subsequently metal-reinforced (not shown).

The C elbow 11 comprises an integrated flow channel connecting a top outlet opening 31 (as shown in the FIG. at the 12 o'clock position) in the feed line 3 with a bottom discharge opening 15 (at 6 o'clock) to the aeration body 5, it being through this integrated flow channel 12 that the gaseous medium can flow, serving to aerate the water body 2. For this purpose the integrated flow channel 12 features an inlet-opening 13 corresponding with the outlet-opening 31 in the feed line 3 and an outlet opening 14 corresponding with the discharge opening 15. The discharge opening 15 is provided at the bottom axial end of a connecting socket 16 provided for connecting the inlet conduit 4. The outlet opening 14 of the integrated flow channel 12 ports into the top axial end of the connecting socket 16. In relation to the feed line 3 the connecting socket 16 is oriented radially outward. Without such a connecting socket 16 the outlet opening 14 and the discharge opening 15 would substantially coincide.

One advantage afforded by this coupling element 10 is to be appreciated in that the outlet opening 31 can now be made in the feed line 3 top-down, i.e. from the supply end in thus reducing the complications in fitting, servicing and repair.

The inlet opening 13 and the outlet opening 14 of the integrated flow channel 12 are arranged facing each other and thus in relation to the cross-section display as shown in FIG. 2, the integrated flow channel 12 covers an angle of at least 180°, it being engineered to extend beyond the inlet opening 13 and outlet opening 14 to enhance the flow in thus covering an angle totaling approx. 120°. Advantageously the integrated flow channel 12 comprises over its length a constant flow cross-section. Since it is configured open at the inner side of the C elbow 11 and is closing off by its application to the outer shell of the feed line 3 it makes for the advantage, among other things, that the C elbow 11 is relatively flexible. Sealing is done by means of sealing cords or O-rings nested in a corresponding groove 17.

Fastening the coupling element 10 to the feed line 3 is done by means of two separate retaining elbows 20a and 20b both of which may be engineered identical. After placement of the coupling element 10 the retaining elbows 20a and 20b are applied to the feed line 3 from the other side of the feed line and secured in place, resulting in the feed line 3 being completely enveloped in the portion concerned. In this arrangement the retaining elbows 20a and 20b positively engage a corresponding solidly configured section 18a and 18b respectively on the coupling element 10. As an alternative the retaining elbows 20a and 20b may also be fastened to the coupling element 10 articulated. By their other ends the retaining elbows 20a and 20b are secured spaced away from each other as may be done e.g. by means of the bolt 21 as shown. Instead of the nut 22 as shown a tapping may be configured in one of the retaining elbows 20a or 20b.

Varying the tensioning with which the coupling element 10 is held angularly and axial positioned on the feed line 3 is done in this example embodiment as shown by the bolt 21, the tensioning or clamping effect being introduced by friction contact. Supplementary to this the inlet opening 13 of the integrated flow channel 12 may be configured collared (not shown) positively engaging the outlet opening 31 in the feed line 3. Instead of the bolt 21 a U-bolt turnbuckle or the like may be provided, and also, instead of two retaining elbows 20a and 20b just one or more than two thereof may be provided.

Referring now to FIG. 3 there is illustrated in a section view the coupling element 110 in a preferred embodiment in accordance with the section A-A in FIG. 1 depicting a preferred way of installing the coupling element 110.

The coupling element 110 takes the form of a pipe clamp comprising an elbow or circumferential portion configured as a C elbow 111 which can now be mounted from without on a feed line 103 by its feeder opening, the C elbow 111 making positive contact with the pipe of the feed line 103 with its circular ring-shaped cross-section. To permit mounting the coupling element 110 it is configured elbowed over an angular range of approx. 180°. Two retaining elbows 120a and 120b each covering an angular range of approx. 90° are preferred releasably connected to the C elbow 111 by two joints 118a, 118b and are fixed in position (as shown in FIG. 3) to the feed line 103 at roughly 2 o'clock by a suitable fastener, such as e.g. a clamping connector 121. Positioning the clamping connector 121 at roughly 2 o'clock now makes it possible to make the fitting above the (to be assumed) water level (WSP) located slightly above the centerline of the feed line 103. A seal 122 seals the integrated flow channel 112 of the coupling element 110 to the feed line 103.

The C elbow 111 comprises an integrated flow channel 117 connecting an outlet opening 131 located as shown in FIG. 3 roughly in the 10 o'clock position in the feed line 103 with a bottom discharge opening 115 (at 6 o'clock) to the aeration body 5 (FIG. 1). Both the inlet opening 113 of the integrated flow channel 112 as well as the corresponding outlet opening 131 in the feed line 103 are positioned in accordance with the invention above the water level WSP in thus making it no problem to assemble or disassemble the coupling element in accordance with the invention above the water level without interrupting operation of the system with the advantages as already described above.

1. A coupling element for connecting at least one aeration body to the feed line of a water aerating device, the said coupling element comprising at least one integrated flow channel for a gaseous medium along an elbow section the inlet opening and outlet opening of said flow channel being arranged at different angular positions.

2. The coupling element as set forth in claim 1, wherein said inlet opening of the integrated flow channel, for a preferred input of the coupling element, is arranged at the top whilst the outlet opening is arranged at the bottom.

3. The coupling element as set forth in claim 1, wherein said inlet opening of the integrated flow channel, for a preferred input of the coupling element, is arranged roughly at the 10 o'clock position whilst the outlet opening is arranged at the bottom.

4. The coupling element as set forth in claim 1, wherein said integrated flow channel covers an angle of 105° to 210°.

5. The coupling element as set forth in claim 1, wherein said integrated flow channel is configured open facing the inner side of the C elbow and by docking the coupling element at the feed line is closed off by the latter.

6. The coupling element as set forth in claim 5, wherein it comprises at least one sealing cord and/or at least one sealing ring arranged in a corresponding groove for sealing the integrated flow channel to the feed line.

7. The coupling element as set forth in claim 1, wherein it is substantially configured as a C elbow and is fastenable to the feed line by at least one corresponding retaining elbow.

8. The coupling element as set forth in claim 7, wherein for its fastening two retaining elbows are provided interconnectable by means of fastener, particularly a bolt/nut.

9. The coupling element as set forth in claim 8, wherein said two retaining elbows are releasably connected to the C elbow by two preferred joints.

10. The coupling element as set forth in claim 1, wherein said outlet opening of the integrated flow channel ports into a connecting socket.

11. The coupling element as set forth in claim 10, wherein said connecting socket is configured in one piece with the coupling element.

12. The coupling element as set forth in claim 1, wherein it is formed in one piece of a flexible plastics material.

13. An aeration device for introducing a gaseous medium into a water body, particularly for introducing a gaseous medium into a water treatment basin, the aeration device comprising at least one feed line and at least one adjoining coupling element as set forth in claim 1 serving to connect at least one aeration body to said feed line.

14. The coupling element as set forth in claim 12, wherein said feed line is engineered as a floating feed line.
